(19) United States
(12) Patent Application Publication
(10) Pub. No.: US 2010/0314284 A1
(43) Pub. Date: Dec. 16, 2010

(54) Collapsible Container

(76) Inventor: Julien Truesdale, Christchurch (NZ)

Correspondence Address: WADDEY & PATTERSON, P.C., 1600 DIVISION STREET, SUITE 500, NASHVILLE, TN, 37203, US

(21) Appl. No.: 12/520,614

(22) PCT Filed: Dec. 19, 2007
(86) PCT No.: PCT/NZ2007/000366

§ 371 Date: Dec. 31, 2009

(30) Foreign Application Priority Data
Dec. 20, 2006 (NZ) 552307

(51) Int. Cl. B65D 69/00; B65D 8/14; B23P 19/04

(52) U.S. Cl. 206/579; 220/666; 100/35; 29/700

(57) ABSTRACT

The invention relates to a collapsible container that presents the environmentally aware user with a reward on crushing. The invention further provides collapsible containers with a locking means to retain the container in a substantially crushed configuration.

### FIELD OF INVENTION

The present invention relates to a collapsible container. More particularly, but not exclusively, the invention relates to the presentation of a token/reward accessible as a result of the collapsing of the container.

### BACKGROUND TO THE INVENTION

Synthetic material containers present an ever expanding problem to waste management throughout the world. Methods for reducing the size of waste material, or possibly more importantly the volume of space that it fills, have been extensively sought. For example empty aluminium cans can simply be crushed and the physical properties of the can ensure that it remains crushed therefore filling a relatively small volume. The plastic/elastic properties of a number of other types of container means that once crushed containers can readily “uncrush” themselves, thus occupying more space.

Prior art in this area suggests several methods for overcoming this problem. Several examples of bellows/concertina sided containers allowing convenient squashing have been proposed. Furthermore, some of these containers contain integral locking devices to hold the containers in a reduced volume. The locking devices in the prior art vary substantially, including threaded screw and nut arrangements, ratchet type arrangements and moulded male/female protrusion/mouldings that can fit snugly together in a “locked” position.

### OBJECT OF THE INVENTION

There would be significant advantage in providing the environmentally aware user of the container with an incentive for crushing the container prior to disposal. Further, it would be an advantage if that incentive was a reward delivered if and when the container had been crushed toward its smallest volume. In addition, there would be further advantage if the locking device effectively sealed the container, thus preventing foreign material entering the container after crushing. Further advantages could be gained should the locking device be reversible, so if at some stage the container needed to be re-used, the locking device could be “unlocked” and the container “uncrushed”.

It follows that an object of one embodiment of the invention is to provide an incentive for crushing containers, on their disposal, so that they may be more effectively dealt with during waste management.

The invention, in one embodiment, aims to provide the incentive by delivering a reward to the user when the container has been appropriately crushed. Further objects will become apparent from the following description.

### SUMMARY OF THE INVENTION

According to one aspect of the invention, there is provided a container comprising a substantially crushable body and a reward access means, wherein a reward is more readily accessible when the container is in a substantially or partially crushed or reduced volume configuration.

Preferably, the structure of the container facilitates a reduction in volume by crushing, or folding or the like.

Preferably, the body of the container has a crushable concertina structure.

Preferably, the container is retained in a substantially crushed configuration.

Preferably, the container is maintained in the substantially crushed configuration when the container is sealed after crushing.

According to a further aspect of the invention, there is a container according to the previous aspect, further comprising a locking means to maintain the container in a substantially crushed configuration.

Preferably, the locking means comprises a protrusion extending from an internal surface of the container, adapted to engage with an engagement means when the container is substantially crushed.

Preferably, the engagement means is located at or about an internal surface of the container, suitable to receive the protrusion on crushing.

Preferably, the protrusion and/or engagement means may extend substantially into the container on a column/stalk

Preferably, the locking means comprises a protrusion extending from an external surface of the container, adapted to engage with an engagement means when the container is substantially crushed.

Preferably, the locking means irreversibly retains the bottle in the crushed configuration.

Preferably, the locking means reversibly locks the bottle in the crushed configuration.

Preferably, the engagement means is at or about a neck and/or opening of the container.

Preferably, the reward is a coin or a token or a collectable or a prize or the like.

Preferably, the reward is located in a cavity on the surface of the container.

Preferably, the cavity is sealed.

Preferably, the container and/or cavity is constructed of substantially opaque material to hide the identity of the reward.

Preferably, the reward is information or a code or a barcode or a readable chip printed or attached to a surface of the container.

Preferably, the reward is unavailable or unreadable when the container is in the uncrushed configuration and is available or readable when the container is in the crushed configuration.

Preferably, part of the reward is printed or otherwise attached to one surface of the uncrushed container and a separate part of the reward is printed or otherwise attached to a non-adjacent surface of the uncrushed container, wherein the parts of the reward may be substantially aligned on adjacent surfaces of the container and become accessible and/or readable when the container is in the crushed configuration.

Preferably, the reward may be substantially hidden under a tab that may be removed or opened to reveal the reward when the container is substantially crushed.

Preferably, the reward access means is integrated into the locking means.

Preferably, the protrusion and/or engagement means is adapted to make the reward more accessible when the container is in a substantially crushed configuration.

Preferably, the reward is located in a cavity at or about the protrusion and/or engagement means and is more accessible when the container is in a substantially crushed configuration.

Preferably, the container is a bottle.

Preferably, the container is plastic.

According to a further aspect of the invention, a container includes a body which is substantially crushable when the container is to be disposed, a locking means to retain the body in a substantially crushed, condition, a reward access means provided for the body and/or the locking means accessible or at least more readily accessible, only in the substantially crushed condition.

According to a further aspect of the invention the reward access means may or may not, selectively, include a reward which when included is accessible or is at least more readily accessible when the body is in the substantially crushed condition.

According to a further aspect of this invention, the reward access means and/or adjacent portions of the container and/or locking means are provided in a material which substantially obscures the presence or absence of a reward with the reward access means.

Preferably a reward is contained within an integral part of the locking mechanism and is thus only available (or at least most conveniently available) when the container is substantially crushed and locked in its crushed condition.

Alternatively a reward is contained within the structure of the container which is not part of the locking mechanism but is only available (or at least most conveniently available) when the container is substantially crushed and locked in its crushed condition.

Preferably the container can be crushed and locked in a relatively compacted volume. At least filling less space than it did prior to crushing.

Preferably the locking device consists of a column attached to the inside surface of the interior of the container such, that it can engage and lock in the neck/opening of the container.

Alternatively, if more convenient, the column can engage and lock onto another surface of the container (for example in the instance when the opening of the container is off centre).

Alternatively, the locking device exists on the inner or outer surface of the container.

Preferably the reward can be accessed from the top of the column when engaged with the opening of the container.

Alternatively the reward can be accessed from a different surface of the container when the locking mechanism is engaged.

Preferably the reward is stored in a chamber/cavity in the top of the column.

Alternatively the reward is stored in a chamber/cavity on a different surface of the container.

Alternatively the reward is located under a tab on top of the column.

Alternatively the reward is located under a tab on a different surface of the container.

Alternatively the reward is on the surface of the container, but is inaccessible/unreadable when the container in not crushed.

Preferably the chamber/cavity can be opened to access the reward.

Alternatively the tab can be torn off or otherwise exposing the reward.

Alternatively the reward is printed on or stuck to the top of the column.

Alternatively the reward is printed on or stuck to a surface of the container.

Preferably the reward is a coin, token, collectible, information or prize of some description.

Preferably the locking mechanism can be unlocked if needed to facilitate at least part uncrushing the container.

According to a further aspect of the invention a method of minimising the space required for containers following their disposal includes;
(i) Providing a container with a crushable structure;
(ii) Providing the container with a locking means adapted to retain the container in a substantially crushed condition;
(iii) Further providing the container or the locking means with reward access means accessible or more readily accessible only in the crushed condition.

According to a further aspect of this invention, the method includes forming portions of said reward access means and/or said locking means and/or container to substantially obscure the presence or absence of a reward with said reward access means.

According to a further aspect of this invention, the method includes the step of selectively including or not including a reward in the reward access means.

According to a further aspect of this invention, there is provided a method of incentivising the crushing of containers for space minimisation including the steps of forming a set of containers, each with a crushable structure.

Providing the container with a locking means adapted to retain the container in a substantially crushed condition.

Providing the container or the locking means with reward access means accessible, or more readily accessible only in the crushed condition.

To providing a reward in a predetermined number of said containers in a manner whereby the presence or absence of said reward is substantially undetectable prior to crushing of said container.

According to a still further aspect a container and/or method of minimising the space required for containers following their disposal is substantially herein described with reference to the accompanying drawings.

Further aspects of the invention which should be considered in all its novel aspects will become apparent from the following description.

### FIGURES

FIG. 1 shows the cutaway side view of a container in one embodiment of the invention.

FIG. 2 shows a cutaway side view of the container of FIG. 1 in a partially crushed configuration. In the partially crushed configuration, the reward part of the invention is not accessible.

FIG. 3 shows a cutaway side view of the container of FIG. 1 in a substantially crushed configuration. In the substantially crushed configuration the locking system engages and the reward aspect of the invention can be accessed.

FIG. 4 shows a cutaway side view of an alternative container where the locking mechanism is offset to allow locking onto another surface of the container. FIG. 4a shows a cutaway side view of the same container in a partially crushed configuration. In the partially crushed configuration, the reward part of the invention is not accessible.

FIG. 5 shows a cutaway side view of the container of FIG. 4 in a substantially crushed configuration. In the substantially crushed configuration, the locking system engages and the reward aspect of the invention can be accessed.

FIG. 6 shows a bottom view of the container of FIG. 4, including the reward chamber.

FIG. 7 shows a bottom view of the container of FIG. 4 illustrating how the reward may be dispensed when the crushed locking mechanism is engaged.

FIG. 8 shows a cutaway representation depicting parts of the container surfaces adapted to form a locking means. The majority of the container is not shown for clarity. FIG. 8a shows the locking means in the unlocked (uncrushed) configuration and FIG. 8b shows the locking means in the locked (crushed) configuration.

FIG. 9 shows a cutaway representation depicting one surface of the concertina side wall of the container adapted to form a plurality of locking means. The majority of the container is not shown for clarity. FIG. 9a shows the locking means in the unlocked (uncrushed) configuration and FIG. 9b shows the locking means as they engage (as the container is crushed).

FIG. 10 shows a cutaway side view of a container with a reward access means independent from the locking means (not shown). FIG. 10a shows the container in the uncrushed configuration and FIG. 10b shows the container in the substantially crushed configuration.

FIG. 11 shows a cutaway side view of a container with a reward access means independent from the locking means (not shown), wherein the container can be crushed sideways to obtain the reward. FIG. 11a shows the container in the uncrushed configuration and FIG. 11b shows the container in the substantially crushed configuration.

FIG. 12 shows 3 cutaway representations depicting parts of the container surfaces adapted to form a reward access means in uncrushed and substantially crushed configurations. The majority of the container is not shown for clarity. FIG. 12a shows a reward access means wherein the reward is covered by a frangible seal. FIG. 12b shows a reward access means wherein the reward is maintained in position in a cavity by the structure of the container. FIG. 12c shows a reward access means wherein the reward is maintained in position in a cavity by the structure of the container.

FIG. 13 shows a side view of an alternative container with a reward access means wherein the reward is held in the engagement means of the locking mechanism on an external surface of the container.

FIG. 14 shows a side view of the container from FIG. 13 in a partially crushed configuration. In the partially crushed configuration, the reward is not accessible.

FIG. 15 shows a side view of the container from FIG. 13 in a substantially crushed configuration. In the substantially crushed configuration, the locking system engages and the reward aspect of the invention can be accessed.

FIG. 16 shows a side view of a container with a projection adapted to make a reward accessible when a container is in a substantially crushed configuration. FIG. 16a shows the container in the uncrushed configuration and FIG. 16b shows the container in the substantially crushed configuration.

FIG. 17 shows a side view of a container with reward printed or otherwise attached to a substantially incompressible member incorporated into a side cavity of the container structure. FIG. 17a shows the container in the uncrushed configuration and FIG. 17b shows the container in the substantially crushed configuration.

FIG. 18 shows a side view of a container where the reward comprises at least two parts printed or otherwise applied to non-adjacent surfaces of the container. In this example, the reward is a barcode.

FIG. 19 shows the container of FIG. 18 in a partially crushed configuration. In the partially crushed configuration, the two parts of the reward are incomplete.

FIG. 20 shows the container of FIG. 18 in a substantially crushed configuration. In the substantially crushed configuration, the two parts of the reward are aligned, adjacent and readable/accessible.

FIG. 21 shows a side view of a container with a coded image printed onto non adjacent surfaces of an uncrushed container that are adapted to come together to ‘decode’ the image on substantial crushing. FIG. 21a shows the container in the uncrushed configuration and FIG. 21b shows the container in the substantially crushed configuration.

### DETAILED DESCRIPTION

In general terms, the invention relates to a method for locking crushed containers in a fully or at least substantially crushed manner. In particular, the invention relates to a method of providing the “crusher” with an incentive or reward for crushing the container.

Through the specification, references have been made to a “reward” and/or “token”. This terminology is intended in a broad sense to describe any form of additional item, such as a coin, gift, collectible, code, barcode, information, graphical representation, indicia, or some other material which will be seen by the recipient as being of “added value” in respect of the article with which it is included. For example, a token, code or barcode may be used to redeem an item of value.

Throughout the specification, the term “crush” and any similar variations relate to the collapsing of a container, so that the container at least occupies a lesser volume than it did prior to collapsing. The terminology is intended in a broad sense to describe any method of reducing the volume of a container by way of squashing, folding, compacting or otherwise compressing: The term “substantially crushed” is not intended to be limiting and may include partially and fully crushed configurations.

In one preferred embodiment of the invention, although not exclusively, preferably the reward token is substantially obscured from view within the container and of cause may be narrowly separated by a openable barrier forming at least a portion of the chamber/cavity, to enable the reward/token to be formed in materials which may otherwise be adversely affected by exposure to the material in the container, or may adversely affect or even contaminate the container content.

On substantially crushing the container, a locking device, suitably integrated into the body of the container, may hold the container in a fully crushed manner.

Furthermore, the act of crushing the container (and engaging the locking device) will furnish the person crushing the container with a reward of some description; this may for example be available from a chamber/cavity accessible when the locking mechanism is engaged. Alternatively, the reward may be information revealed from a surface of the container only when the container is crushed.

As will be readily apparent to a person skilled in this area, the invention could be applied to a wide range of crushable or compactable containers such as plastic bottles, milk containers, plastic drums and the like. In addition, the invention may be applied to boxes or other types of package that may be crushed.

For the purposes of this specification, reference has been made to several types of bottle. Such references should not be seen to be limiting and the term “container” is used herein to describe any type of article which could be suitable for crushing before disposal.

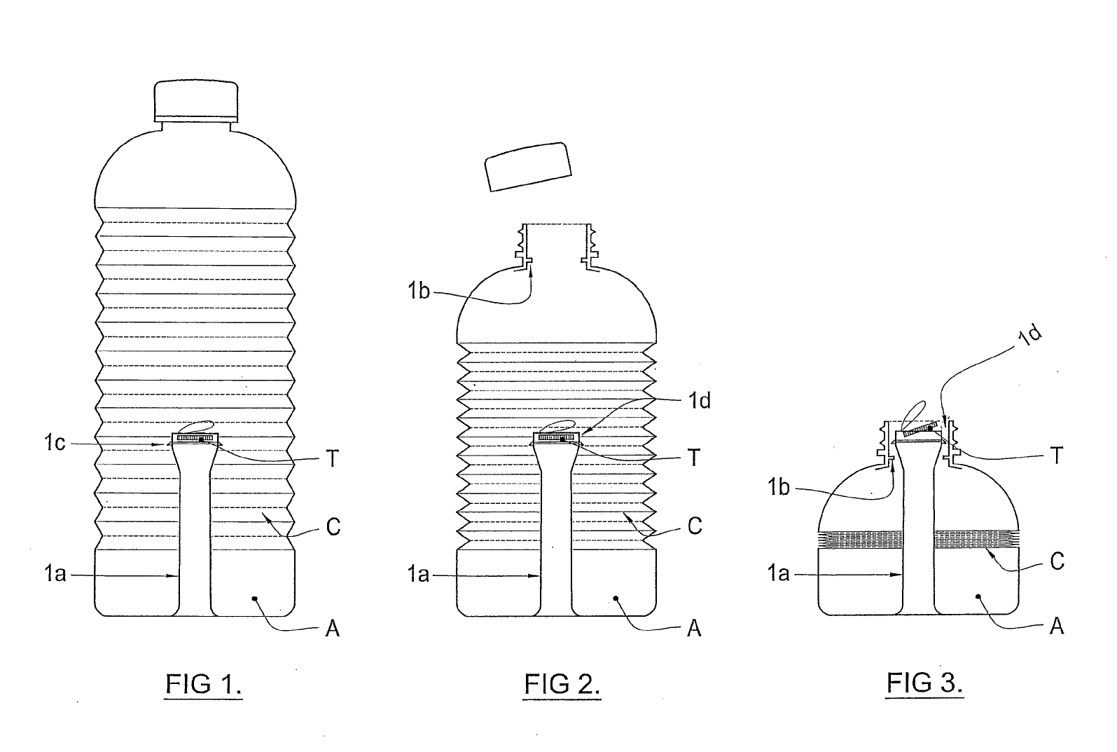

FIG. 1 shows a cutaway side view of one possible embodiment of the invention. The container illustrated in FIG. 1 is a bottle (A) wherein the body of container has a ribbed concertina sidewall structure (C) to facilitate crushing. The bottle includes a locking means comprising a protrusion (1a) extending from the internal bottom surface of the bottle and an engagement means. The protrusion may form part of a column or stalk a column or stalk adapted to engage with the engagement means. The size of the protrusion and/or column/stalk will be dependent on the distance between the relevant surfaces of the container in the substantially crushed configuration.

The column or stalk (1a) may protrude substantially vertically from the base of the bottle. The top of the column or stalk is shown with a flared rim (1c) which may be complementary to an engagement means comprising a slightly smaller rim (1b) running around the inner surface of the neck or opening of the bottle. When the container is ready for disposal, the container can be crushed, thus filling a smaller volume and achieving more efficient waste management.

The top of the column includes a reward access means comprising a cavity or chamber (1d) containing a reward (T).

FIG. 2 shows a cutaway side view of the partially crushed bottle. When the bottle is not completely crushed and locked the reward remains inaccessible.

FIG. 3 shows a cutaway side view of the bottle in a substantially crushed configuration. The flared sides of the top of the column (1c in FIG. 1) may be adapted to engage with a rim running round the inner surface of the opening of the container (1b) thus locking it in the substantially crushed configuration. FIG. 3 also illustrates how the reward can be accessed from the chamber/cavity (1d) in the top of the column (1a), through the opening at the top of the container. On substantial crushing, the top of the column is presented at or about the opening of the container.

The reward (T) may be stored in a sealed or unsealed chamber/cavity accessed through a tearaway strip or tab or alternatively may automatically be forced open on engagement of the locking device or otherwise.

The reward may be an object of some description, e.g a coin or token or collectible, or printed information of some value or amusement to the user. Alternatively, the reward may be information or a code, a barcode or a readable chip printed on or otherwise attached to a surface of the container only accessible or readable when the container is substantially crushed. For example, the reward may be printed or applied to the top of the column/stalk and may be read or removed for redemption.

The column or stalk illustrated in FIGS. 1-3 may be of sufficient height to engage with the neck of the container when the container is crushed. If the column is shorter, the container may need to be crushed further and vice-versa but is preferably relative in size to the height of the container.

The locking means illustrated in FIGS. 1-3 may seal the container when engaged. The top of the column may fit tightly into the neck when engaged not only effectively locking the container in the crushed manner but also sealing the container. In addition, the locking device may be operated in such a way as to be “unlocked” so the container could be “uncrushed” if needed.

Furthermore, the locking means may alternatively exist as a screw-thread/nut arrangement, a ratchet type arrangement or moulded male/female protrusion/moulding or other arrangement described in the prior art, easily used in conjunction with the reward delivery method.

Alternatively, the container may be adapted to be maintained in a substantially crushed configuration without a locking means. For example, the container may be constructed of a non elastic material such as metal or card. In a further embodiment, the container may be adapted to be maintained in a substantially crushed configuration when the container is sealed. For example, a plastic bottle with a lid may be retained in the substantially crushed configuration when the lid is secured following crushing.

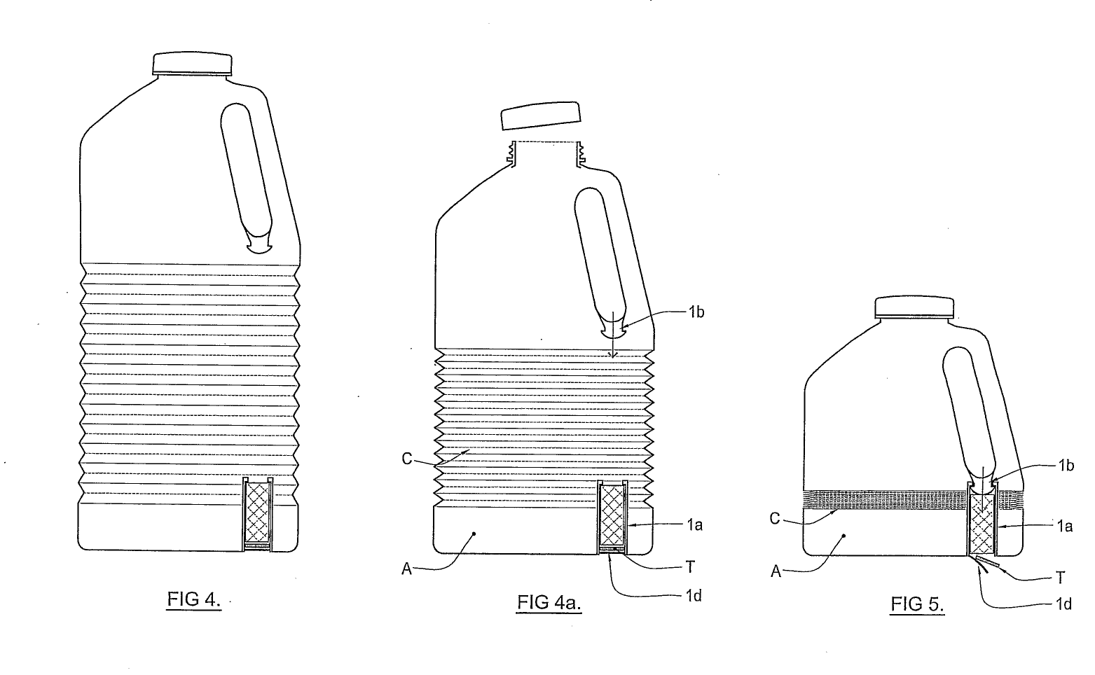

FIG. 4 shows a cutaway side view of an alternative container (A) with ribbed concertina sides (C). In this embodiment, the engagement means (1a) extends into the container on a column or stalk and is aligned with an opposing complimentary protrusion (1b), which can be offset from the centre of the container. In this case the reward (T) may be embedded in a chamber/cavity (1d) in the bottom of the container at the base of the column. One aspect of the locking mechanism could be an integral part of the container which is illustrated in FIG. 4, where the lowest point of the handle of a milk bottle style container has a flared protrusion (1b) extending vertically down. The flared protrusion may lie substantially directly above the column (1a) which may have the corresponding female docking cavity (engagement means) in the top. In this illustration the docking cavity may have an engageable ring around the top which when engaged with the protrusion (1b) will lock.

FIG. 5 shows how the container (A) can be crushed and how the protrusion (1b) locks into the engagement means at the top of the column (1a). FIG. 5 also illustrates one method for reward delivery. By pushing down the column during the locking sequence, the reward (T) is forced out of the chamber/cavity (1d) at the base of the column.

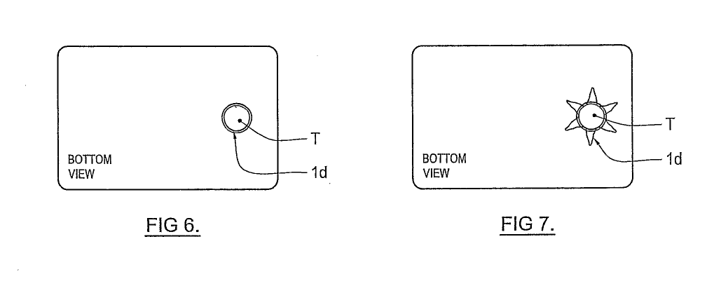

FIG. 6 illustrates the embodiment of the closed chamber/cavity (1d) in the base of the container, which may be sealed with a frangible or scored covering that may be easily opened with a downward pressure of the column when crushing the container.

FIG. 7 illustrates an option for the convenient opening of the sealed chamber/cavity. In the example illustration, it will be appreciated that downward pressure of the stalk or column effectively puts pressure on the chamber/cavity (1d), which is preferably formed as a substantially sealed container, but has substantially frangible lines of weakening, such as score lines or the like of one portion of the chamber/cavity, to thus enable breaking open of the chamber/cavity to expose the reward.

The protrusion of the locking means need not protrude from the base of the container, but may protrude from another convenient surface. The protrusion, in fact, need not comprise a column or stalk at all, but some other construction designed to engage with an engagement means or anchor point effectively holding the container substantially crushed thus facilitating the presentation of the reward.

The locking means in the symmetrical type container (e.g FIG. 1-3) and the non-symmetrical type container (e.g FIG. 4-7) could be independent of the reward access means in the invention, providing the reward was accessible once the crush locking means had been engaged.

The independent locking means may comprise a screw-thread/nut arrangement, a ratchet type arrangement or moulded male/female protrusion/moulding or other described in the prior art, easily used in conjunction with the reward delivery method. In addition, the locking device may be operated in such a way as to be “unlocked” so the container could be “uncrushed” if needed.

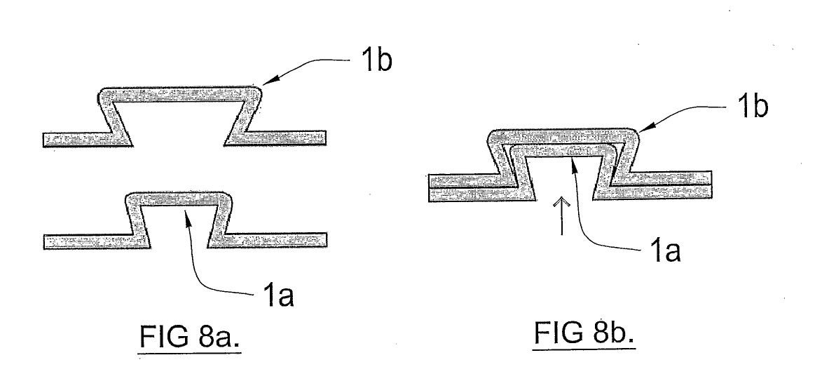

Referring to FIGS. 8a and b, the locking means can be incorporated into the construction of the side walls of the container. The protrusion (1a) on one surface of the container can engage and lock into the engagement means (1b) on a separate surface of the container, locking the container in a crushed configuration as shown in FIG. 8b.

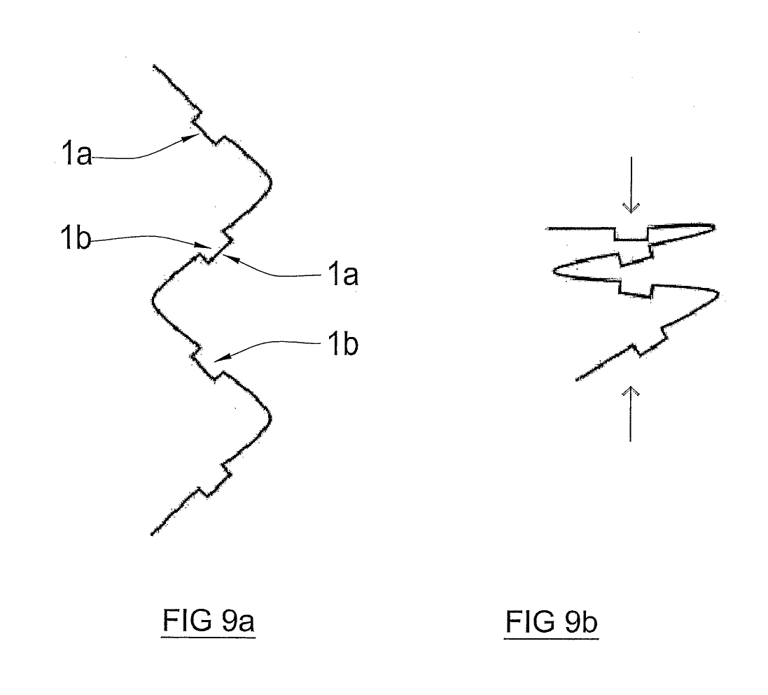

Furthermore, a container with a concertina wall structure can be constructed with a plurality of opposing protrusions (1a) and engagement means (1b) as shown in FIG. 9a. On substantial crushing, the surfaces of the concertina walls may come together and the plurality of opposing protrusions (1a) and engagement means (1b) engage and lock the container in a crushed configuration as shown in FIG. 9b.

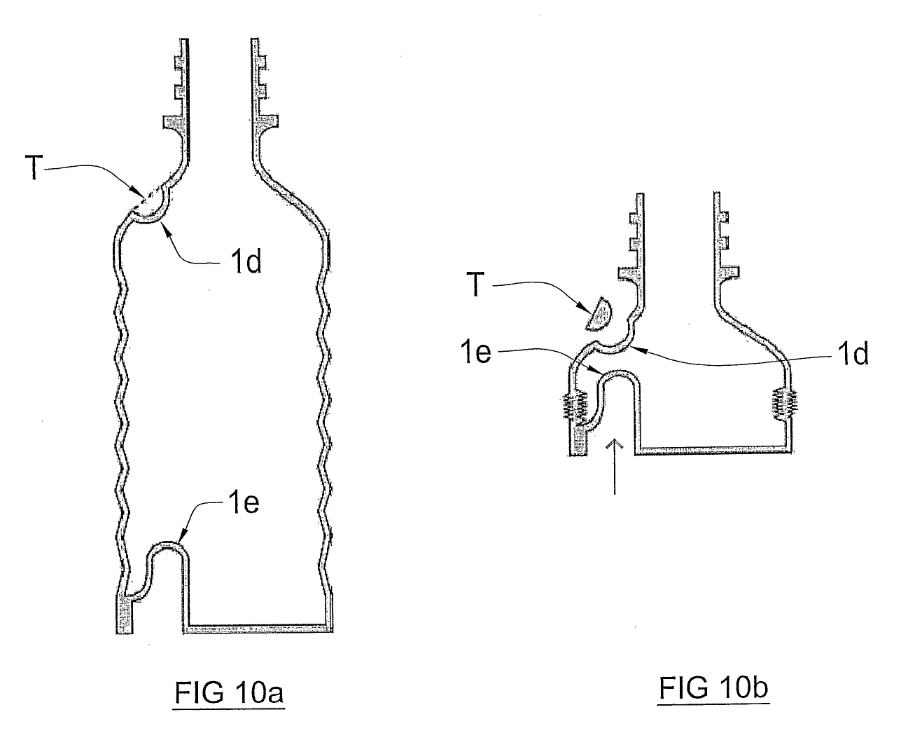

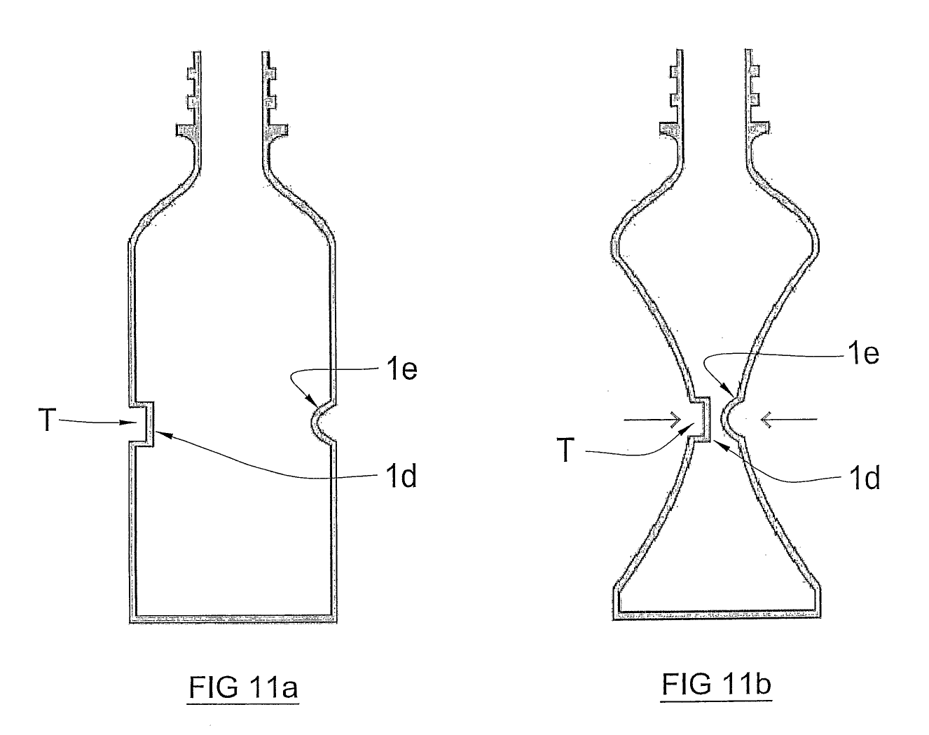

Referring to FIGS. 10a and 10b, the reward access means may be independent from the locking means (not shown). In some embodiments of the invention, the locking means may not be needed at all. In this example, when the container is substantially crushed, a projection (1e) on an inner surface of the container, independent of the locking means, forces the reward (T) out of the cavity (1d) located in the neck of the container.

FIGS. 11a and 11b illustrate an alternative embodiment of the invention, wherein the container can be substantially crushed sideways. The projection (1e) may be located on an opposing internal sidewall surface of the container as shown in FIG. 11a. On substantial sideways crushing, the projection (1e) may contact and distort the cavity (1d) thus exposing the reward (T).

It is to be appreciated that in alternative preferred forms of the invention, the reward may also be exposed via a frangible seal, for example by a pull tab and the like, for example accessible through the opening of the crushed container, to expose the reward or taken for retrieval.

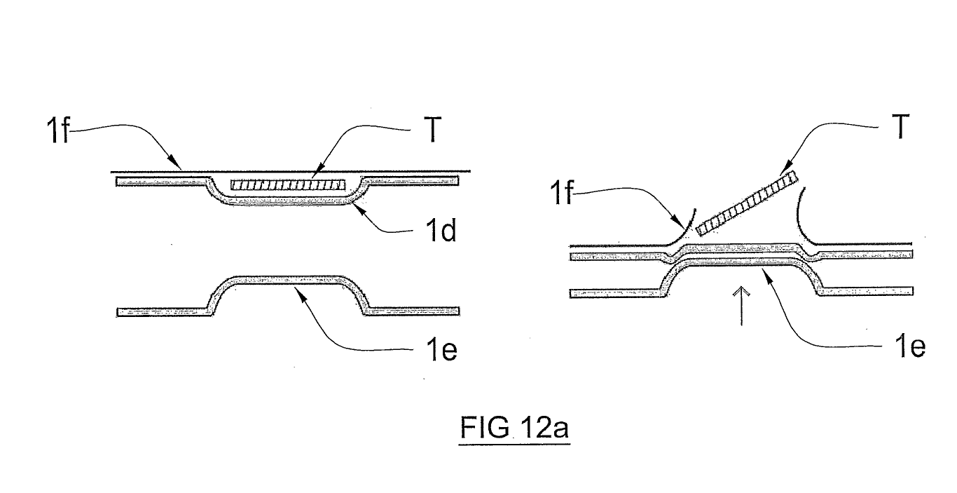

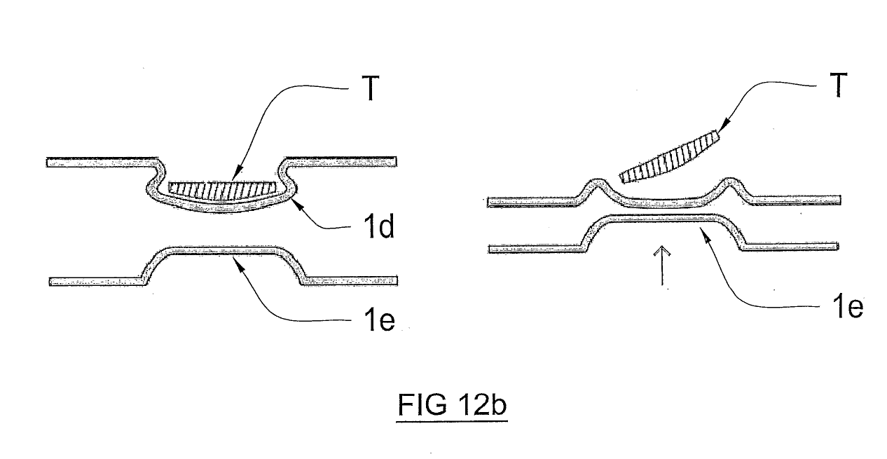

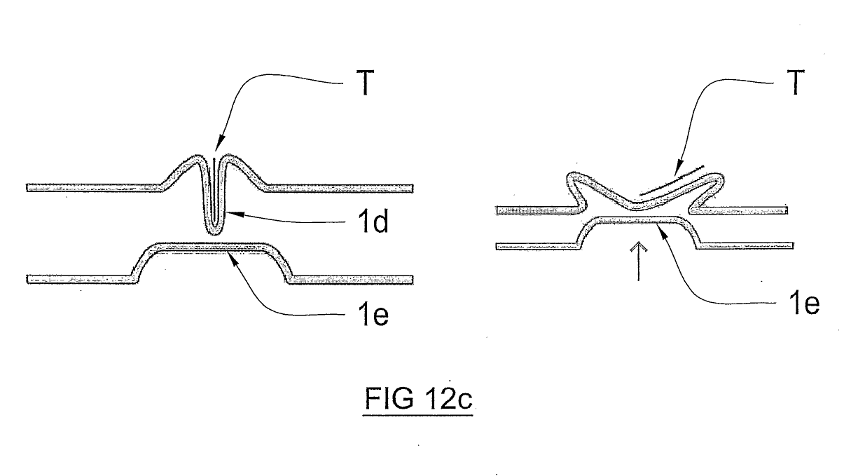

FIGS. 12a-c show alternative reward access means, wherein the reward T is located in a cavity (1d) in the uncrushed configuration. On substantial crushing of the container, the projection (1e) may come into contact with and distort the cavity (1d), thus exposing the reward (T). FIG. 10a shows the reward (T) hidden beneath a frangible seal (1f), which may be broken on substantial crushing to expose the reward (T).

The locking device may not necessarily be on the inside of the container, but may be more conveniently located outside, or in a recess or aperture through the container, created from the internal chamber defined by the container for material containment. The locking device may also be conveniently located wholly on the exterior of the container.

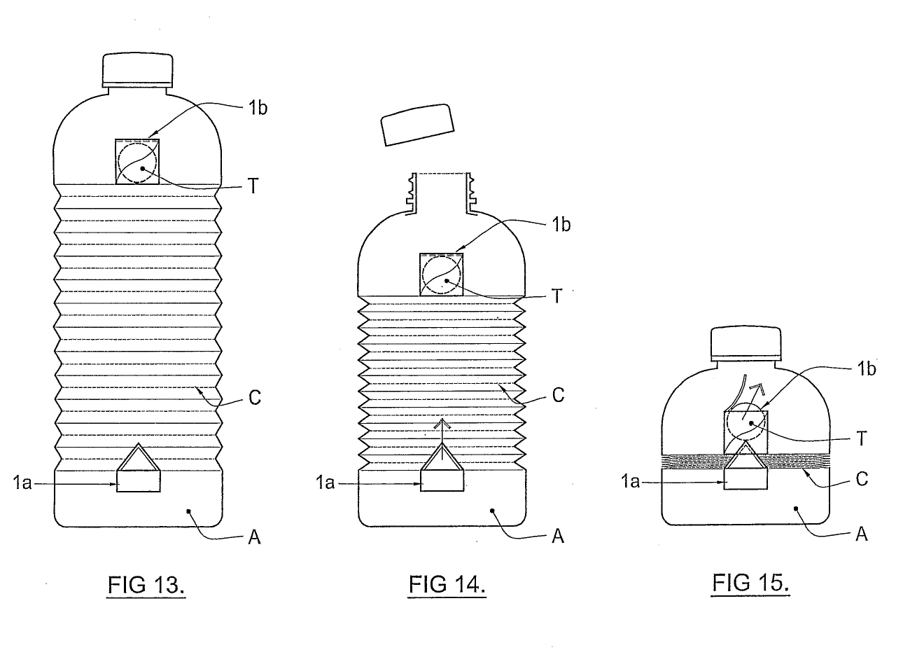

Referring to FIG. 13, the protrusion (1a) and engagement means (1b) of the locking mechanism may be located on the exterior surface of the container (A). In this example, the reward (T) is located at or about the engagement means (1b). FIG. 14 shows the container in the partially crushed configuration, wherein the reward is not accessible as the container is not substantially crushed.

Referring to FIG. 15, on substantial crushing, the protrusion (1a) may force the reward (T) out of the engagement means (1b), thus making is accessible. The protrusion (1a) may also engage with the engagement means (1b), thus locking the container in the substantially crushed configuration.

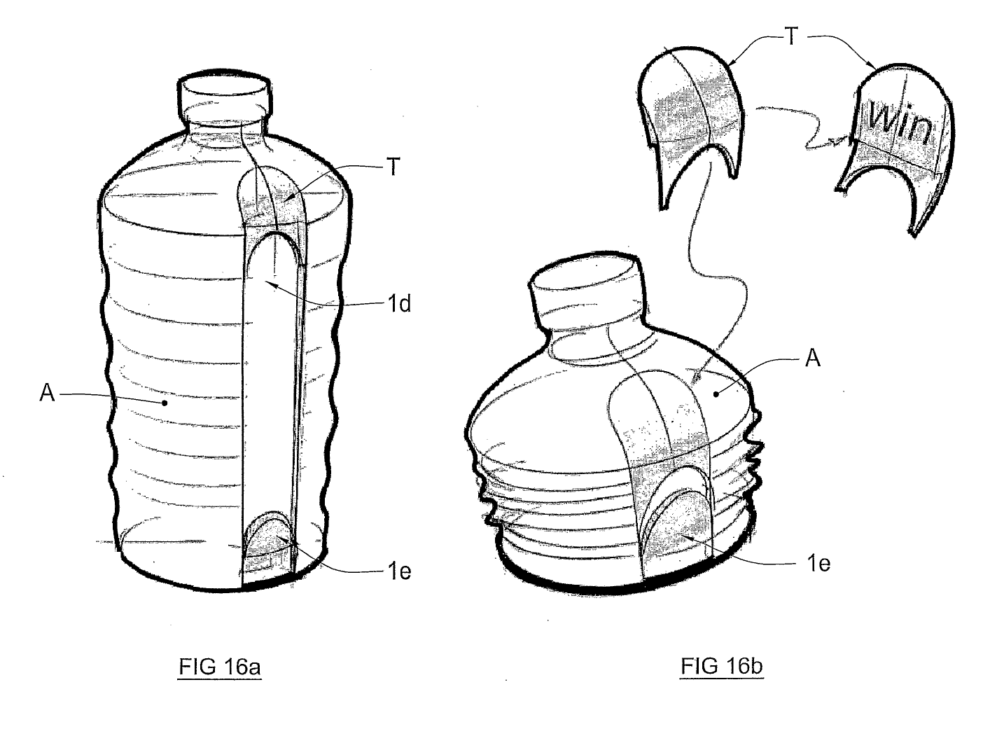

FIG. 16 shows an alternative embodiment of the invention, wherein a projection (1e) forms part of the reward access means on an outer surface of the container (A) and is not necessarily part of the locking mechanism. The projection (1e) is aligned with the reward (T) on the crushing axis. On substantial crushing, the projection (1e) forces the reward (T) out of a cavity (1d) making it accessible.

If a projection is used as an integral part of the reward access means, it may extend from any surface of the surface (internally or externally) providing it is adapted to present a reward on substantial crushing. For example, the projection may extend from a container cap. In this embodiment, the cap with the projection may be removed from the container, the container crushed and the cap replaced. On replacing and securing the cap, the projection may contact a cavity in the base of a container and displace a reward. This projection may also be adapted to form part of a locking means.

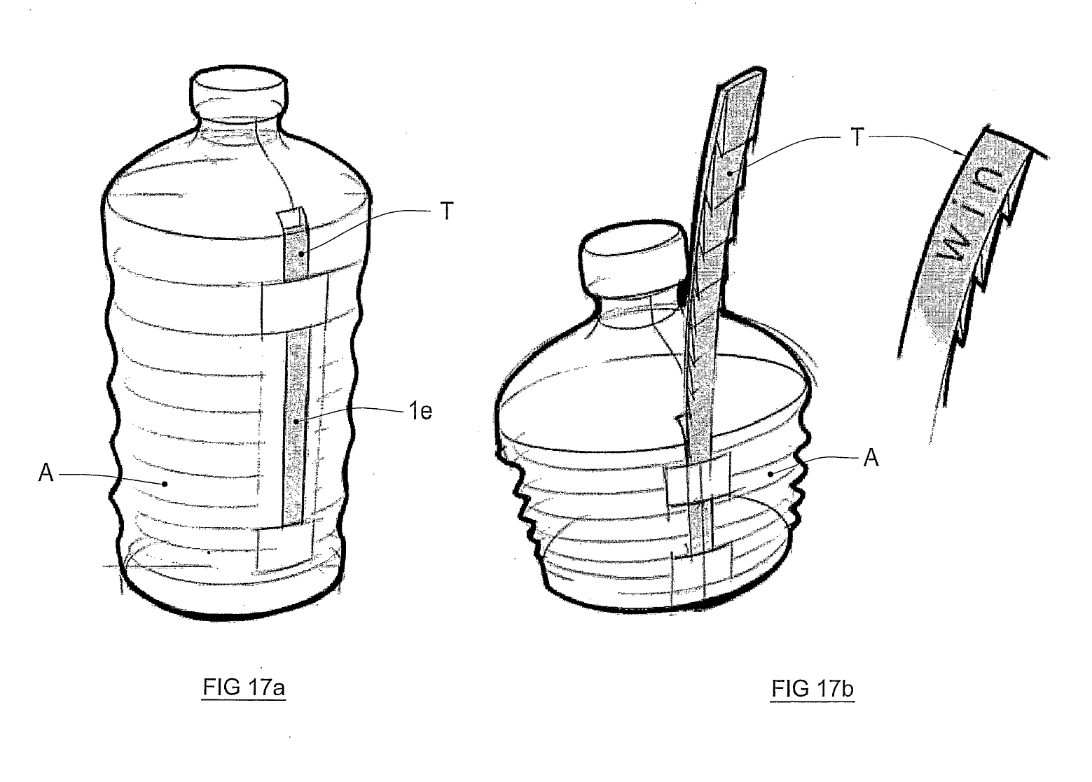

FIG. 17 shows a further embodiment of the invention, wherein the reward (T) is printed or otherwise attached to a substantially incompressible member (1e) and may be located on the inner or outer surface of the container (A). In the uncrushed configuration the identity of the reward is hidden by the construction of the container. On substantial crushing of the container, the substantially incompressible member is unsheathed to reveal the reward (T).

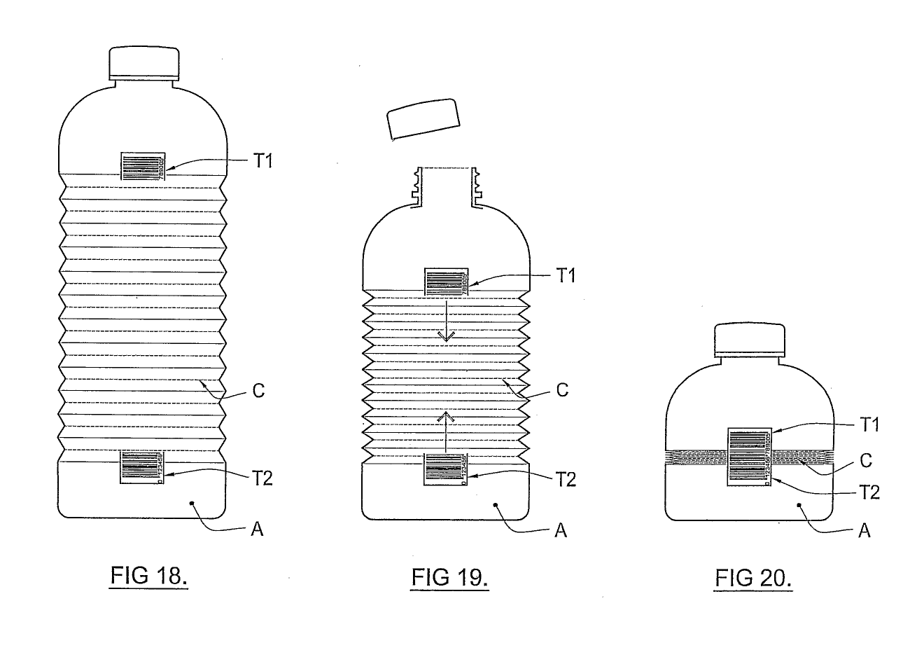

FIG. 18 outlines a further embodiment where the reward comprises a barcode. However, in this embodiment, the reward may also be a code, a graphical representation or the like. In this example the reward comprises at least two parts (T1 and T2) printed or otherwise applied to non adjacent surfaces of the uncrushed container (A) and are unreadable/inaccessible. On partial crushing (FIG. 19), the two parts of the reward are not adjacent, and are therefore still unreadable/inaccessible.

Referring to FIG. 20, on substantial crushing, the parts of the reward are aligned on adjacent surfaces of the container and are readable/accessible. The reward may be realised when the parts of the reward are aligned. Alternatively, the reward may be used to redeem an item of value. For example, in one embodiment where the reward is a code or barcode, the reward may be read by a reader and an item of value dispensed.

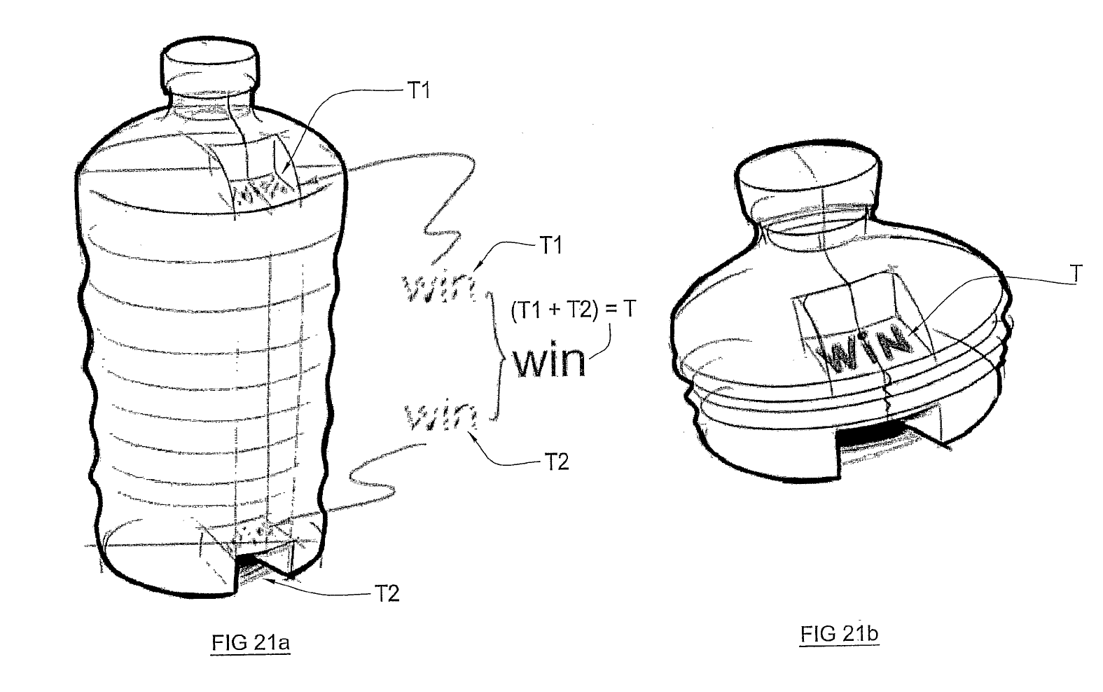

Referring to FIGS. 21, T1 and T2 may comprise graphical representations or coded images on opposing surfaces of the container. In the uncrushed configuration, the graphical representation or coded image is unreadable or indecipherable. On substantial crushing, the surfaces on which T1 and T2 are applied come together and reveal a readable/decipherable or accessible coded image or graphical representation (T) when the surfaces are aligned/adjacent.

In a further embodiment, the coded image or graphical representation may be matched against a further code or representation separately accessible, for example from a separate area of the container, such as inside the container cap. Matching the codes may result in the redemption of a reward.

In one embodiment, the crushed container with the barcode may be deposited into a storage or disposal bin or receptacle with a barcode reader. On depositing the crushed container, the barcode may be read by the barcode reader and a prize may be dispensed or points toward a redeemable item of value may be earned.

The majority of the figures illustrate a crushable container with concertina sides, however it would be possible to operate the invention with a twisting type crushing construction or indeed any other method for crushing or folding outlined in the prior art.

The majority of the figures outline crushing the container down the vertical axis. It is also possible to squash the container along the horizontal axis e.g sideways. The locking device and reward presentation aspects could also be applied to the sideways squashed container.

The protrusion and engagement means will preferably be aligned when the container is adapted to be crushed down the vertical axis. However, they may be offset from each other (i.e. not axially aligned) in embodiments where the container is not crushed down the vertical axis. For example in bottles where a twisting type crushing can be used.

It is anticipated that the invention will enable incentive based promotion of containers in accordance with the present invention, which additionally encourages responsible space saving disposal of the container after use, either by the purchaser or consumer of the contents of the container, or by others. In this form of the invention, it is envisaged that a plurality of similar containers may be provided substantially in a predetermined set and that a predetermined or random selection of the containers in the set can be provided with the reward; other containers of that set do not have a reward.

It is to be appreciated that the term “set” is used in a generalised context to perhaps describe a predetermined production run of a few containers, or many containers over a relatively long production like cycle.

In this form of the invention, it is preferred that portions of the chamber/cavity (1d), or portion of the container associated therewith are provided in substantially translucent or opaque materials such that the presence or absence of a reward with the container is obscured until such time as the container is crushed and the chamber/cavity is opened. In this way, it will be appreciated that, preferably associated with appropriate promotion, the possible existence of a reward or token in a container, potentially incentivises all those who come into contact with the container from purchase through to ultimate disposal to crush the container to ascertain whether or not a reward/token is present, thus achieving preferred space minimisation of waste.

In an alternative form of the invention it is also envisaged that portions of the container/cavity may be provided in substantially transparent or translucent material, particularly where, for example, the container is formed in substantially transparent material, for example P.E.T. and the like, it is envisaged that in this form of the invention, the reward or token may be of recognised value, for example a coin or other identifiable valuable.

In these circumstances it is envisaged that each container of the invention would contain a reward or token.

Where a token or similar form of reward is provided, such token could preferably be formed in a non harmful material and of a size and shape to best avoid unintended or dangerous ingestion. In particular, the token could be formed in a material which is additionally able to breakdown, such as by dissolving or crumbling should it be accidentally ingested.

In a further embodiment of the invention, it is anticipated that the reward or token could comprise an article or material having some form of palliative or antidotial property addressing perceived adverse effects, such as odours, or the like as a result of consumption of container contents, for example breath fresheners, anti-acids, peppermints and the like.

In summary, the invention describes a method of crushing a collapsible container to facilitate waste management and a container for this purpose. Furthermore, preferably the invention provides an incentive for this environmentally friendly act by presenting the user with an actual or potential reward of some description associated with collapsing of the container.

The reference to any prior art in this specification is not, and should not be taken as, an acknowledgment or any form of suggestion that that prior art forms part of the common general knowledge in New Zealand or in any other country in the world.

Throughout this specification, unless the context requires otherwise, the words “comprise”, “comprising” and the like, are to be construed in an inclusive sense as opposed to an exclusive sense, that is to say, in the sense of “including, but not limited to”.

Although the foregoing describes the invention and a preferred form thereof, alterations or modifications which would be apparent to a person skilled in this particular art are intended to be included within the scope and spirit of the invention described.

Where the foregoing description includes reference to any specific components or integers of the invention having known equivalents then such equivalents are herein incorporated as if individually set forth.

1-34. (canceled)

35. A container comprising:
a substantially crushable body; and
a reward wherein the reward is more readily accessible when the container is in a substantially or partially crushed or folded configuration compared to when the container is in an uncrushed or unfolded configuration.

36. A container according to claim 35, wherein the structure of the container facilitates crushing or folding.

37. A container according to claim 35, wherein the body of the container has a crushable concertina structure.

38. A container according to claim 35, wherein the container is retained in a substantially crushed configuration.

39. A container according to claim 38, wherein the container is maintained in a substantially crushed configuration when the container is sealed after crushing.

40. A container according to claim 35, wherein the container further comprises a locking means to maintain the container in a substantially crushed configuration.

41. A container according to claim 40, wherein the locking means comprises a protrusion extending from an internal or external surface of the container, adapted to engage with an engagement means when the container is substantially crushed.

42. A container according to claim 40, wherein the reward is integrated into the locking means.

43. A container according to claim 42, wherein the protrusion and/or engagement means is adapted to make the reward more accessible when the container is in a substantially crushed configuration.

44. A container according to claim 43, wherein the reward is located in a cavity at or about the protrusion and/or engagement means and is more accessible when the container is in a substantially crushed configuration.

45. A container according to claim 40, wherein the locking means reversibly locks the bottle in the crushed configuration.

46. A container according to claim 35, wherein the reward is a coin or a token or a collectable or a prize or the like.

47. A container according to claim 46, wherein the reward is located in a cavity on the surface of the container.

48. A container according to claim 35, wherein the reward is legible or otherwise accessible information or a code or a barcode or a readable chip printed or attached to a surface of the container.

49. A container according to claim 48, wherein the reward is unavailable or unreadable when the container is in the uncrushed configuration and is available or readable when the container is in the crushed configuration.

50. A container according to claim 48, wherein part of the reward is printed or otherwise attached to one surface of the uncrushed container and a separate part of the reward is printed or otherwise attached to a non-adjacent surface of the uncrushed container, wherein the parts of the reward are substantially aligned on adjacent surfaces of the container and become accessible and/or readable when the container is in the crushed configuration.

51. A container according to claim 35, wherein the reward is substantially hidden under a tab that may be removed or opened to reveal the reward when the container is substantially crushed.

52. A method of minimizing space required for containers including:
providing a container with a crushable and/or foldable structure; and
providing the container with a reward, wherein the reward is more readily accessible when the container is in a substantially or partially crushed or folded configuration compared to when the container is in an uncrushed or unfolded configuration.

53. A method according to claim 52, wherein the container further comprises a locking means to retain the container in a substantially crushed configuration.

54. A method of incentivizing the crushing of containers for space minimization, including the steps of:
providing a number of containers, each with a crushable structure; and
providing a reward for each container, wherein the reward is more readily accessible when the container is in a substantially or partially crushed or folded configuration compared to when the container is in an uncrushed or unfolded configuration.
